(19) United States
(12) Patent Application Publication
(10) Pub. No.: US 2017/0135369 A1
(43) Pub. Date: May 18, 2017

(54) COMPOSITION FOR PRODUCING CHEWING GUM

(71) Applicant: WUG FUNCTIONAL GUMS, S.L., Doña Mencia (ES)

(72) Inventors: Jose Luis ROJANO JORGE, Dona Mencia (ES); Jordi CLARAMONTE CALLEJON, Dona Mencia (ES)

(21) Appl. No.: 15/317,248

(22) PCT Filed: Jun. 3, 2014
(86) PCT No.: PCT/ES2015/070272

§ 371 Date: Dec. 8, 2016

(30) Foreign Application Priority Data
Jun. 10, 2014 (ES) P201430889

(51) Int. Cl. A23G 4/06; A23G 4/10

(52) U.S. Cl. CPC A23G 4/068; A23G 4/10

(57) ABSTRACT

COMPOSITION FOR PRODUCING CHEWING GUM that, apart from chewing gum made from polyvinyl acetate, xanthan gum or Sapodilla tree sap, also includes at least caffeine and Panax ginseng, and optionally any of the following ingredients:
Ptychopetalum olacoides (also known as Mura Puama)
Rhodiola Rosea
Turnera diffusa (commonly known as Damiana)
Lepidium meyenii (also known as Maca)
Tribulus Terrestris (also known as Caltrop)
Steviol glycosides (E-960), as a natural sweetener
Spearmint aroma
Silicon oxide
Magnesium stearate

### OBJECT OF THE INVENTION

As set out in the title of this descriptive report, the invention refers to a composition for producing chewing gum.

Field of the Invention

The field of the present invention is the food industry and in particular, the food supplements market. It also includes the OTC product and confectionery sectors and more specifically, the chewing gum sector.

Background of the Invention

In reference to the current state of the art, it should be mentioned that although an infinite number of compositions exist for producing chewing gum that include multiple varieties and flavours, including some with stimulating ingredients, the applicant, at least, is not aware of the existence of any that present the composition described and claimed herein.

### INVENTION DISCLOSURE

In particular, the present invention refers to a composition for producing chewing gum with invigorating and energising properties in which, apart from the gum or chewing gum base made with polyvinyl acetate, xanthan gum or with Sapodilla tree sap, it also includes at least caffeine and Panax ginseng (commonly known as true ginseng).

Optionally however, the described composition may also include any one, various or all of the following ingredients:
Ptychopetalum olacoides (also known as Mura Puama)
Rhodiola Rosea
Turnera diffusa (commonly known as Damiana)
Lepidium meyenii (also known as Maca)
Tribulus Terrestris (also known as Caltrop)
Guarana seed extract
Spearmint aroma
Silicon oxide
Magnesium stearate

Furthermore, in the preferred embodiment, the composition also includes a quantity of between 4 and 5 mg of steviol glycosides (E960) derived from the natural sweetener stevia.

In the preferred embodiment, to produce each piece of chewing gum, the composition comprises a variable quantity of chewing gum of between 1 and 1.5 g and the following ingredients, in the indicated quantities:
Caffeine 30 mg.
Panax ginseng 12 mg.
Ptychopetalum olacoides 5.61 mg.
Rhodiola Rosea 3.40 mg.
Turnera diffusa 2.72 mg.
Lepidium meyenii 2.72 mg.
Tribulus Terrestris 2 mg.

In an alternative variant of the invention, the composition for producing each piece of chewing gum comprises between 1 and 1.5 g of chewing gum and:
Caffeine 40 mg
Panax ginseng 30 mg
Guarana seed extract 20 mg

In this alternative variant of the invention, the preferred composition for producing each piece of chewing gum comprises 1337.5 mg of chewing gum and:
Caffeine 40 mg
Panax ginseng 30 mg
Guaranta seed extract 20 mg
Spearmint aroma 30 mg
Steviol glycosides (E-960) 5 mg
Silicon oxide 7.5 mg
Magnesium stearate 30 mg

Having described in sufficient detail the nature of this invention and the way it is put into practice, it is not considered necessary to go into further length about its disclosure to allow an expert in the matter to understand its scope and the advantages it brings. It is hereby stated that based on its essential characteristics, it can be put into practice in other forms of elaboration that differ in detail from that indicated as an example, which will also be included in the protection sought, provided its fundamental principle is not altered, changed or modified.

1-11. (canceled)

12. A composition for producing chewing gum that includes chewing gum and is made with polyvinyl acetate, xanthan gum or Sapodilla tree sap, wherein it also contains caffeine and Panax ginseng.

13. The composition for producing chewing gum as set out in claim 12, wherein it also contains Ptychopetalum olacoides.

14. The composition for producing chewing gum as set out in claim 12, wherein it also contains Rhodiola Rosea.

15. The composition for producing chewing gum as set out in claim 12, wherein it also contains Turnera diffusa.

16. The composition for producing chewing gum as set out in claim 12, wherein it also contains Lepidium meyenii.

17. The composition for producing chewing gum as set out in claim 12, wherein it also contains Tribulus Terrestris.

18. The composition for producing chewing gum as set out in claim 12, wherein to produce one piece of chewing gum, apart from between 1 and 1.5 g of chewing gum, the following is also required:
Caffeine 30 mg.
Panax ginseng 12 mg.
Ptychopetalum olacoides 5.61 mg.
Rhodiola Rosea 3.40 mg.
Turnera diffusa 2.72 mg.
Lepidium meyenii 2.72 mg. and
Tribulus Terrestris 2 mg.

19. The composition for producing chewing gum as set out in claim 12, wherein it also includes Guarana.

20. The composition for producing chewing gum as set out in claim 19, wherein to produce one piece of chewing gum, in addition to between 1 and 1.5 g of chewing gum, it contains 30 mg of Panax ginseng, 40 mg of Caffeine and 20 mg of Guarana.

21. The composition for producing chewing gum as set out in claim 12, wherein it includes the natural sweetener steviol glycolides (E-960).

22. The composition for producing chewing gum as set out in claim 12, wherein each piece of chewing gum produced contains 1337.5 mg of chewing gum and:
Caffeine 40 mg
Panax ginseng 30 mg
Guarana seed extract 20 mg
Spearmint aroma 30 mg
Steviol glycosides (E-960) 5 mg
Silicon oxide 7.5 mg
Magnesium stearate 30 mg
